(19) United States
(12) Patent Application Publication
(10) Pub. No.: US 2007/0220255 A1
(43) Pub. Date: Sep. 20, 2007

(54) Connection authentication system, communication device, image printer or image data storage device, control program and connection authentication method

(75) Inventor: Hiroshi Igarashi, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/717,141

(22) Filed: Mar. 13, 2007

(30) Foreign Application Priority Data
Mar. 14, 2006 (JP) 2006-069844

(51) Int. Cl. H04L 9/32; H04L 9/00; H04K 1/00; G06K 9/00; G06F 17/30; G06F 7/04

(52) U.S. Cl. 713/170; 726/2; 380/270

(57) ABSTRACT

The present invention provides a connection authentication system, a communication device, an image printer or image data storage device, a control program and a connection authentication method capable of making the connection authentication between devices by a simple operation in the wireless communication system, with no increase in cost. For example, according to the connection authentication system of the present invention, the report device can supply the function of connection authentication without having the device for connection authentication, whereby the connection authentication between devices can be made by a simple operation, with no increase in cost.

### BACKGROUND OF THE INVENTION

1. Field of the Invention

The present invention relate to a connection authentication system, a communication device, an image printer or image data storage device, a control program and a connection authentication method, and more particularly to a technique capable of making connection authentication between devices by a simple operation in a wireless communication system, with no increase in cost.

2. Description of the Related Art

Conventionally, in making wireless communication using a wireless LAN or Bluetooth, it is required to perform a recognition operation for specifying the communication party at the other end to enable connection and communication.

With the prior art, an NFC (Near Field Communication), RFID (Wireless Frequency IDentification) or the like capable of near distance communication is provided with connection information, and the connection authentication is enabled by making the devices closer to communicate in short distance.

Also, with the prior art, it is presupposed to mount a plurality of communication devices (dedicated for near distance communication or dedicated for long distance communication), in which the near distance communication device is used for connection authentication, and the long distance communication device is used for transferring large capacity data (refer to Japanese Patent Application Laid-Open No. 2004-364145).

### SUMMARY OF THE INVENTION

However, to realize the above technique, it is required to mount communication hardware/software dedicated for near distance communication to make the connection authentication, resulting in a problem that the cost and development load are needed. Also, there is another problem that some complicated operations (IrDA (Infrared Data Association), QR code (Quick Response Code), and button operation) for making the connection authentication are required.

The present invention has been achieved in the light of the above-mentioned problems, and it is an object of the invention to provide a connection authentication system, a communication device, an image printer or image data storage device, a control program and a connection authentication method capable of making the connection authentication between devices by a simple operation in the wireless communication system, with no increase in cost.

In order to accomplish the above object, the present invention provides a connection authentication system for making wireless communication between a first communication device and a second communication device, the first communication device comprising a generation device for generating a unique pattern capable of identifying uniquely the first communication device, a report device, used for different purposes from the wireless communication with the second communication device, for presenting an information to a user or invoking an attention of the user, the report device being capable of outputting the unique pattern, and a first communication unit for making the wireless communication with the second communication device, and the second communication device comprising an input device for accepting an input of the unique pattern, an authentication device for making a connection authentication of the first communication device based on the unique pattern, and a second communication unit for making the wireless communication with the first communication device, wherein if the authentication device of the second communication device authenticates the connection of the first communication device using the unique pattern outputted from the report device of the first communication device, the wireless communication is started between the first communication unit and the second communication unit.

Therefore, the report device can supply the function of connection authentication without having the device for connection authentication, whereby the connection authentication between devices can be made by a simple operation, with no increase in cost.

Also, the first communication device may be a portable terminal unit with a camera or an image pickup device that transmits image data by wireless, and the second communication device may be an image printer for printing the image data or an image data storage device for storing the image data.

Thereby, in the wireless communication between the portable terminal unit with camera or the image pickup device that transmits image data by wireless and the image printer for printing the image data or the image data storage device for storing the image data, the connection authentication can be made using the report device without having the device for connection authentication.

Also, the invention provides a communication device for making wireless communication with other communication devices, comprising a generation device for generating a unique pattern capable of identifying uniquely the communication device, a report device, used for different purposes from the wireless communication with the other communication devices, for presenting an information to a user or invoking an attention of the user, the report device being capable of outputting the unique pattern, and a communication unit for making the wireless communication with the other communication devices if a connection authentication is made based on the unique pattern.

Therefore, the report device can supply the function of connection authentication without having the device for connection authentication, whereby the connection authentication between devices can be made by a simple operation, with no increase in cost.

Also, the generation device may generate a prescribed flashing pattern as the unique pattern, and the report device may be a light emitting device for emitting visible light based on the flashing pattern.

Thereby, the connection authentication between devices can be practiced based on the prescribed flashing pattern.

Also, the communication device may comprise a liquid crystal monitor or a light emitting diode having a backlight, and the light emitting device may be the backlight or light emitting diode.

Thereby, the flashing pattern can be outputted using the liquid crystal monitor or the light emitting diode having the existent backlight on the communication device.

Also, the generation device may generate a prescribed sound pattern as the unique pattern, and the report device may be a sound generator for generating a sound based on the sound pattern.

Therefore, the sound pattern can be generated as the unique pattern, whereby the connection authentication between devices can be practiced by producing the sound from the sound generator.

Also, the generation device may generate a prescribed vibration pattern as the unique pattern, and the report device may be a vibrator for generating a mechanical vibration based on the vibration pattern.

Thereby, the vibration pattern can be generated as the unique pattern, whereby the connection authentication between devices can be practiced by producing the vibration from the vibrator.

Also, the unique pattern may be a signal corresponding to any of an IP address, a MAC address and a serial number of the communication device.

Therefore, the unique pattern can include the identification information unique to the communication device, whereby the communication party subjected to connection authentication can be specified.

Also, the communication device may be a portable terminal unit with a camera or an image pickup device capable of making the wireless communication of image data.

Also, the invention provides a communication device for making wireless communication with other communication devices outputting a unique pattern capable of identifying uniquely the communication device, comprising an input device for accepting an input of the unique pattern, an authentication device for making a connection authentication of the other communication devices based on the unique pattern, and a communication unit for making the wireless communication with the other communication devices if the connection authentication is made.

Therefore, the unique pattern capable of identifying uniquely the communication device can be acquired, whereby the connection authentication of the other communication device outputting its unique pattern can be made.

Also, the other communication devices may output a visible light emitted based on a prescribed flashing pattern, and the input device may be a light receiving device for receiving the visible light.

Therefore, the flashing pattern of visible light can be outputted as the unique pattern, whereby the connection authentication can be practiced by receiving the light of its flashing pattern.

Also, the other communication devices may produce a sound based on a prescribed sound pattern, and the input device may be a microphone for inputting the sound.

Therefore, the sound pattern can be produced as the unique pattern, whereby the connection authentication can be practiced by inputting the sound from the microphone.

Also, the communication device may further comprise an extraction device for extracting unique identification information by making a Fourier transform process for the sound inputted from the microphone.

Therefore, the frequency component of sound can be calculated, whereby the connection authentication can be practiced based on the calculated frequency component. Also, the pattern can be hidden not to discern the unique pattern only by hearing it aurally.

Also, the other communication devices may produce a mechanical vibration based on a prescribed vibration pattern, and the input device may be a shock sensor for detecting the vibration.

Therefore, the vibration pattern can be produced as the unique pattern, whereby the connection authentication can be practiced by detecting the vibration with the shock sensor.

Also, the invention provides a device for printing an image and/or storing an image data, the device having the communication device according to any one of the above-described aspects of the present invention.

Thereby, the image printer or image data storage device can make the connection authentication of the other communication devices, using the unique pattern outputted from the other communication devices for making the wireless communication.

Also, the invention provides a control program for a communication device having a report device, used for different purposes from wireless communication with other communication devices, for presenting an information to a user or invoking an attention of the user, the program causing a computer to perform a step of generating a unique pattern capable of identifying uniquely the communication device, and a step of outputting the unique pattern from the report device.

Therefore, the unique pattern capable of identifying uniquely the communication device can be generated using the report device, used for different purposes from the wireless communication with other communication devices, for presenting the information to the user or invoking an attention of the user, and the generated unique pattern can be outputted.

Also, the invention provides a connection authentication method for making wireless communication between a first communication device and a second communication device, the first communication device comprising a step of generating a unique pattern capable of identifying uniquely the first communication device, a step of outputting the unique pattern to a report device, used for different purposes from the wireless communication with the second communication device, for presenting an information to a user or invoking an attention of the user, and the second communication device comprising a step of accepting an input of the unique pattern, a step of making a connection authentication of the first communication device based on the unique pattern, and a step of making the wireless communication between the first communication device and the second communication device.

Therefore, the device for connection authentication is not provided, but the report device can supply the function of connection authentication, whereby the connection authentication between devices can be made by a simple operation, with no increase in cost.

With this invention in the wireless communication system, the existent report device is utilized as the device for connection authentication to reduce the number of parts, whereby the connection authentication between devices can be made by a simple operation, with no increase in cost.

### BRIEF DESCRIPTION OF THE DRAWINGS

FIG. 1 is a schematic diagram showing the hardware configuration of a wireless communication system according to the present invention;

FIG. 2 is a rear view of a digital camera;

FIG. 3 is a schematic block diagram showing the configuration of the digital camera;

FIG. 4 is a schematic block diagram showing the configuration of a printer;

FIGS. 5A and 5B are schematic diagrams for explaining a light emission circuit of the digital camera and a light receiving circuit of the printer;

FIG. 6 is a schematic diagram showing flashing patterns;

FIG. 7 is a block diagram of a control program stored in the digital camera;

FIG. 8 is a block diagram of a control program stored in the printer;

FIGS. 9A and 9B are flowcharts showing the processing flow of connection authentication;

FIG. 10 is a schematic block diagram showing the configuration of another digital camera;

FIG. 11 is a schematic block diagram showing the configuration of another printer;

FIGS. 12A and 12B are schematic diagrams for explaining a connection authentication operation using a sound pattern;

FIGS. 13A and 13B are flowcharts showing the processing flow of connection authentication using the sound pattern;

FIG. 14 is a schematic block diagram showing the configuration of a mobile telephone;

FIG. 15 is a schematic block diagram showing the configuration of a printer 30;

FIGS. 16A and 16B are schematic diagrams for explaining a connection authentication operation using a vibration pattern;

FIGS. 17A and 17B are flowcharts showing the processing flow of connection authentication using the vibration pattern; and

FIG. 18 is a perspective view of a shop front terminal unit 15 according to a fourth embodiment of the invention.

### DETAILED DESCRIPTION OF THE PREFERRED EMBODIMENTS

The preferred embodiments of a connection authentication system, a connection authentication control program, a communication device, and a receiver according to the present invention will be described below in detail with reference to the accompanying drawings. Throughout all the drawings for explaining the embodiments of the invention, the parts having the same function are designated by the same numerals, and not described repeatedly.

### First Embodiment

A first embodiment involves the connection authentication using a report device for presenting the information or invoking the attention of the user visually, for example, a backlight of a liquid crystal monitor or an LED.

### [Schematic Configuration of System]

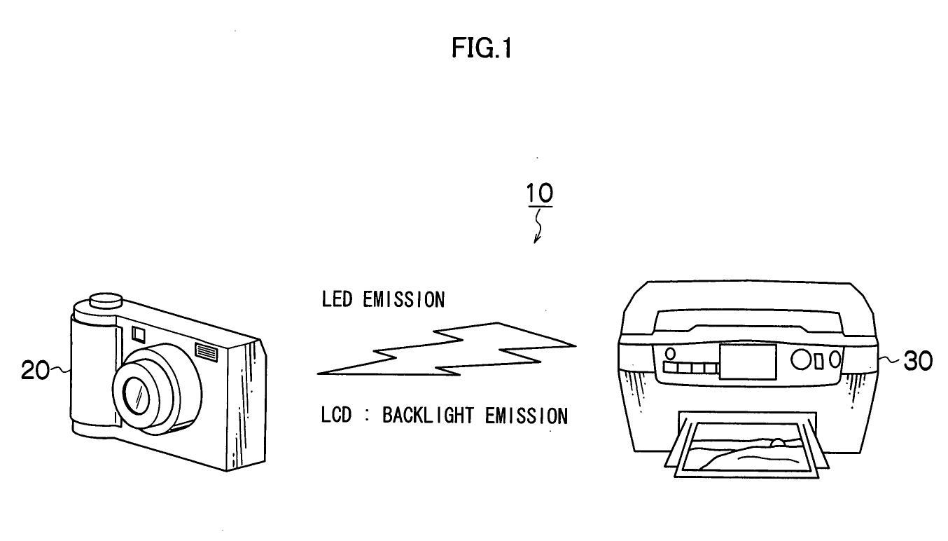

FIG. 1 is a schematic diagram showing the hardware configuration of a wireless communication system 10 according to the invention. The wireless communication system 10 comprises a first communication device 20 having a wireless communication function and a second communication device 30 that makes the wireless communication with the communication device 20 by connecting it, and has a connection authentication system for enabling the wireless communication between these devices.

The first communication device 20 may be a portable terminal unit with a camera (mobile telephone, PDA and so on) for transmitting image data by wireless, or an image pickup device (digital still camera and so on) for transmitting image data by wireless. The second communication device 30 may be an image printer for printing image data or an image data storage device for storing image data, such as an electronic album.

In the first embodiment, an instance where the digital camera 20 as the first communication device 20 and the printer 30 as the second communication device 30 are used will be described below.

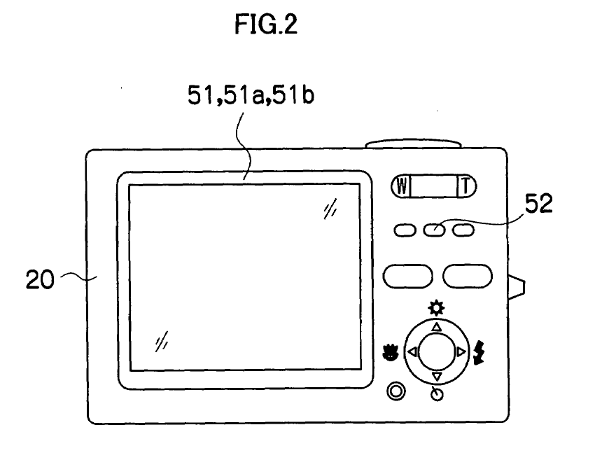

The digital camera 20 has a liquid crystal monitor (hereinafter referred to as a “LCD”) 51 with a liquid crystal panel 51a and a backlight 51b as a light emitting device and a light emitting diode (hereinafter referred to as an “LED”) 52 on the back face of the digital camera 20, as shown in FIG. 2. The backlight 51b of the LCD 51 and the LED 52 emit the light based on a flashing pattern capable of identifying uniquely the digital camera 20.

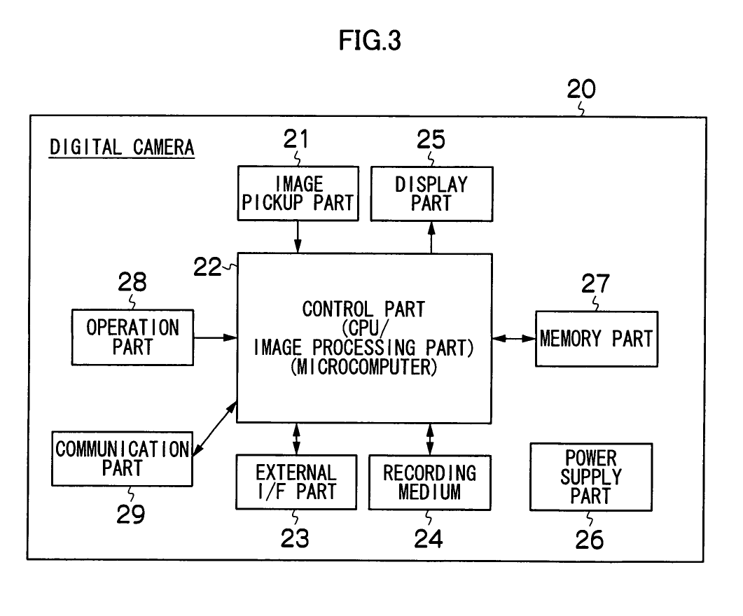

Referring to FIG. 3, the hardware configuration of the digital camera 20 will be described below. FIG. 3 is a block diagram showing the configuration of the digital camera 20. The digital camera 20 comprises an image pickup part 21, a control part (CPU/image processing part) 22, an external I/F part 23, a recording medium 24, the LCD 51 having the liquid crystal panel 51a and the backlight 51b laminated (see FIG. 2), a power supply part 26, a memory part (ROM/RAM) 27, an operation part 28 and a communication part 29.

The image pickup part 21 comprises an optical unit having an image area sensor such as CCD/CMOS and the lenses, in which photographed image data is sent to the image processing part of the control part 22.

The control part (CPU/image processing part) 22 has a CPU for making various controls of the digital camera 20 as the core, in which image data from the image pickup part 21 or image data from the recording medium 24 is subjected to various kinds of image processing/conversion to generate display data or recording data.

The external I/F part 23 is used for connection to a peripheral device such as a PC or a printer 30, not shown, and may be an external I/F (USB, IEEE1394, SCSI, LAN, IrDA, Bluetooth, W-LAN, W-USB, etc.) that can be controlled from the outside to make various communications or the transmission or reception of image data.

The recording medium 24 is removable image recording media, or image recording media built into the digital camera 20, or may be a writable, erasable large capacity storage such as memory, HDD or DVD. The recording medium 24 stores photographed image data after image processing.

The display part 25 comprises a member for presenting the information to the user or invoking the attention of the user through the vision. Specifically, the display part 25 displays the recorded image or movie image, a menu or the character on operation, or the power ON/OFF state of device. The display part 25 comprises the LCD 51 having the liquid crystal monitor and the backlight 51b, not shown, laminated, and the LED 52 that informs the user of the alert or the power ON/OFF state.

The backlight 51b of the LCD 51 and the LED 52 dynamically light up (e.g., 10 Hz) according to a certain flashing pattern controlled by a microcomputer to reduce power consumption. By associating this flashing pattern with information, such as IP address, MAC address or serial number, for identifying uniquely the digital camera 20, the unique pattern can be outputted.

The flashing pattern can be generated differently for each device by changing software. That is, the flashing pattern for connection authentication can be generated by updating the conventional control program that dynamically turns on the backlight 51b or the LED 52 mounted on the digital camera 20 to the following control program, whereby the flashing visible light can be outputted.

The power supply part 26 has an I/F with a battery or an external power supply to supply a desired voltage to the device in each block.

The memory part (ROM/RAM) 27 comprises a ROM storing the control program of the digital camera 20 and a RAM that the control part uses as the work area or to store image data.

The operation part 28 includes a user I/F such as keys, a touch panel and so on. A signal inputted from the operation part 28 is sent to the control part 22. The operation or mode of the digital camera is set up and controlled in accordance with the state of this operation part 28.

The communication part 29 is a long distance communication device to make the wireless communication of large capacity data such as image data.

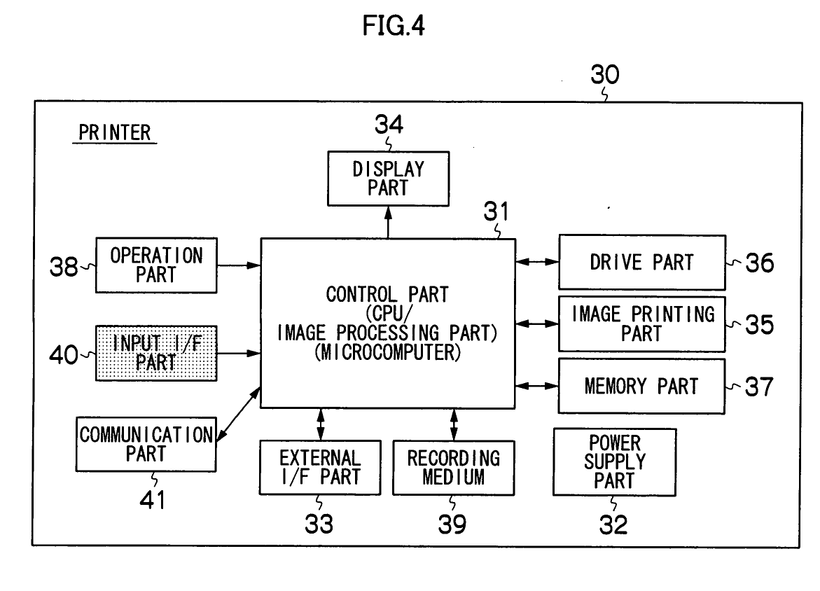

Referring to FIG. 4, the hardware configuration of the printer 30 will be described below. FIG. 4 is a block diagram showing the configuration of the printer 30.

The printer 30 comprises a control part 31, a power supply part 32, an external I/F part 33, a display part 34, an image printing part 35, a drive part 36, a memory part (ROM/RAM) 37, an operation part 38, a recording medium 39, an input I/F part 40, and a communication part 41.

The control part 31 is a control board for operating the printer 30, and includes a CPU, various kinds of memory, a print controller, a drive system driver IC and various kinds of sensor I/F.

The power supply part 32 is a unit for supplying power required for the operation of the printer to supply a voltage to each block by transforming power from AC power supply to various kinds of DC power supply required inside the printer 30.

The external I/F part 33 is an external I/F (USB, IEEE1394, SCSI, LAN, IrDA, Bluetooth, etc.) for enabling the external control by connection to a host (PC, controller, etc.). Incidentally, the printer 30 can be operated alone.

The display part 34 comprises a member for presenting the information to the user or invoking the attention of the user through the vision. For example, the display part 34 comprises a member for displaying the printed image, a menu or the character on operation, or the power ON/OFF state of device, and is composed of the LCD and the LED.

The image printing part 35 comprises a print head for the printer, a substrate, and a heat sink. The drive part 36 includes a stepping motor or a DC motor for driving the internal mechanism or conveying the print paper.

The memory part (ROM/RAM) 37 comprises a ROM storing the control program of the printer 30 and a RAM that the control part 31 uses as the work area or to store image data. The operation part 38 includes a user I/F such as keys, a touch panel and so on. A signal inputted from the operation part 38 is sent to the CPU of the control part 31. The operation or mode of the printer 30 is set up and controlled in accordance with the state of this operation part 38.

The recording medium 39 is removable image recording media, or image recording media built into the printer, or may be a writable, erasable large capacity storage such as memory, HDD or DVD. The recording medium 39 stores photographed image data after image processing.

The input I/F part 40 includes a phototransistor for receiving visible light, and detects a flashing pattern from another device (e.g., digital camera 20) to make the connection authentication. The phototransistor inputs communication protocol information into the control part 31.

The communication part 41 is a long distance communication device to make the wireless communication of large capacity data such as image data.

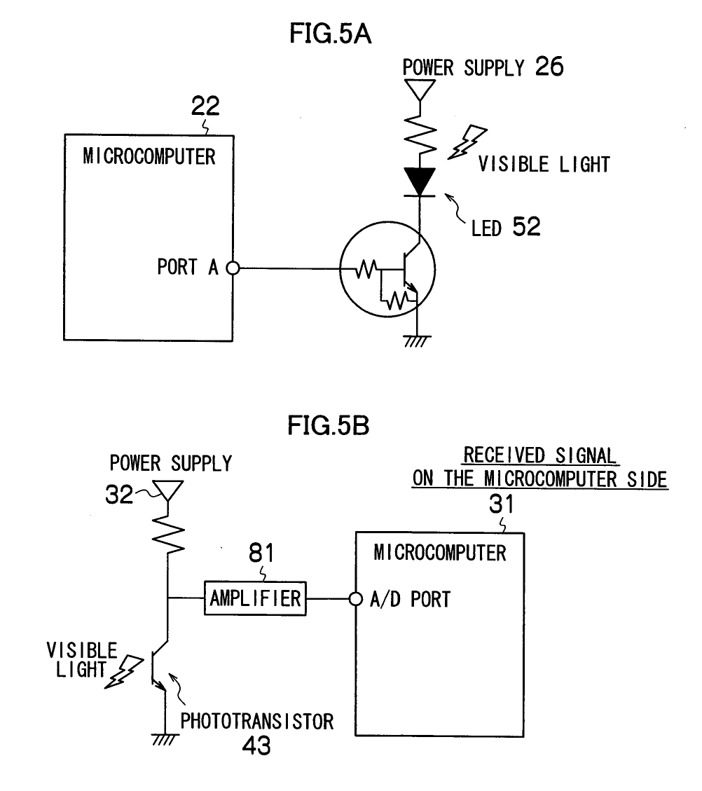

Referring to FIGS. 5A and 5B, the configuration of the light emitting circuit of the digital camera 20 and the light receiving circuit of the printer 30 will be described below. FIGS. 5A and 5B are schematic diagrams for explaining the configuration of the light emitting circuit of the digital camera 20 and the light receiving circuit of the printer 30. FIG. 5A is a circuit configuration diagram showing an example of the light emitting circuit using the LED 52 of the digital camera 20. Though the explanation is given for the LED 52 herein, the same circuit configuration may be applied to the backlight 51b.

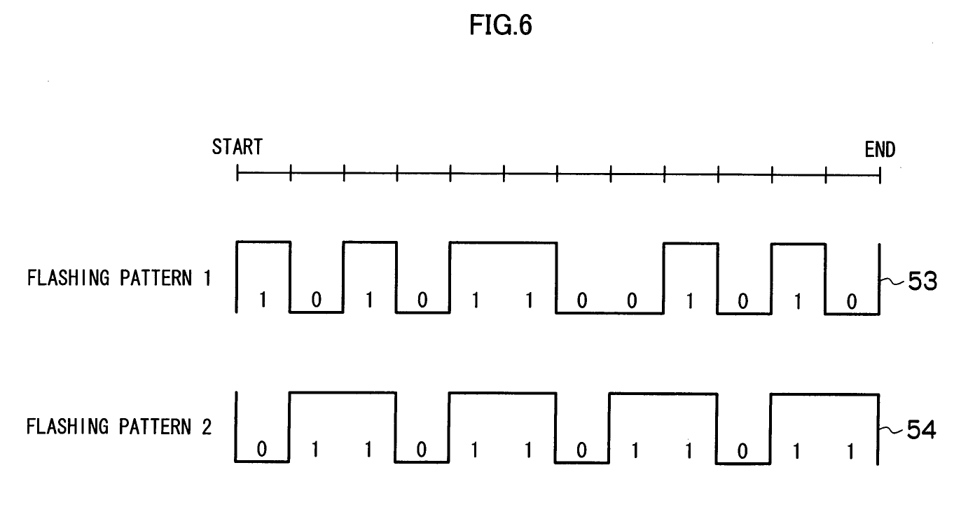

In FIG. 5A, the control part (microcomputer) 22 built into the digital camera 20 is connected to the power supply part 26, the LED 52 and various resistors. A voltage from the power supply part 26 is applied to the LED 52. The control part 22 outputs a control signal corresponding to a flashing pattern (1) 53 or a flashing pattern (2) 54, for example, shown in FIG. 6 from a port A. These flashing patterns (1) 53 and flashing pattern (2) 54 provide a signal capable of identifying uniquely the digital camera, corresponding to any one of the IP address, MAC address and serial number of the digital camera 20. The unique pattern may include a flashing pattern indicating the start of unique pattern at the top and a flashing pattern indicating the end at the last.

The LED 52 dynamically lights up along the flashing pattern to output the flashing patterns 53 and 54 as the unique pattern.

Referring to FIG. 5B, the circuit configuration of the light receiving circuit for the input I/F part 40 of the printer 30 will be described below. FIG. 5B is a circuit configuration diagram showing an example of the light receiving circuit.

In FIG. 5B, a microcomputer 31 built into the printer 30 and constituting the control part 31 is connected to an amplifier 81, which is connected to the power supply part 32, the phototransistor 43 and various resistors. A voltage from the power supply 32 is applied to the phototransistor 43. The phototransistor 43 receives visible light outputted by the digital camera 20 and makes the photoelectric conversion. A current produced thereby is amplified by the amplifier 81, and converted into a digital signal by an A/D converter provided at an A/D port of the microcomputer 31.

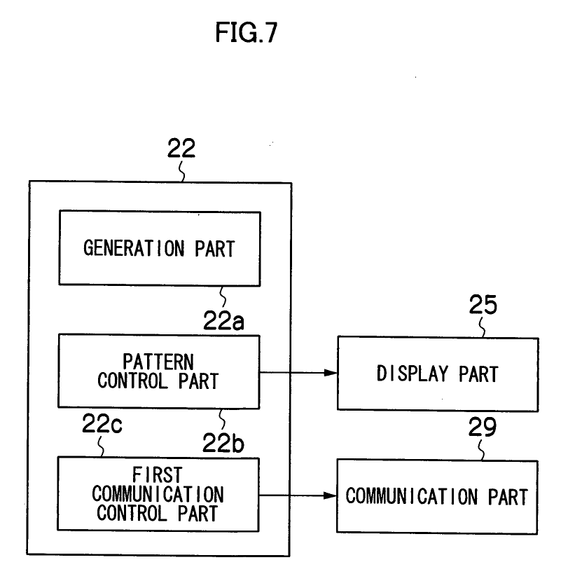

Referring to FIG. 7, a control program performed by the control part 22 of the digital camera 20 will be described below. The control program comprises a generator 22a for generating the unique pattern capable of identifying uniquely the digital camera 20, a pattern control part 22b for controlling the flashing pattern on the display part 25, based on the unique pattern generated by the generator 22a, and a first communication control part 22c for controlling the wireless communication with the printer 30 after connection authentication based on the unique pattern via the communication part 29. The control part 22 loads these control programs onto the memory part 27 to be executed by the CPU.

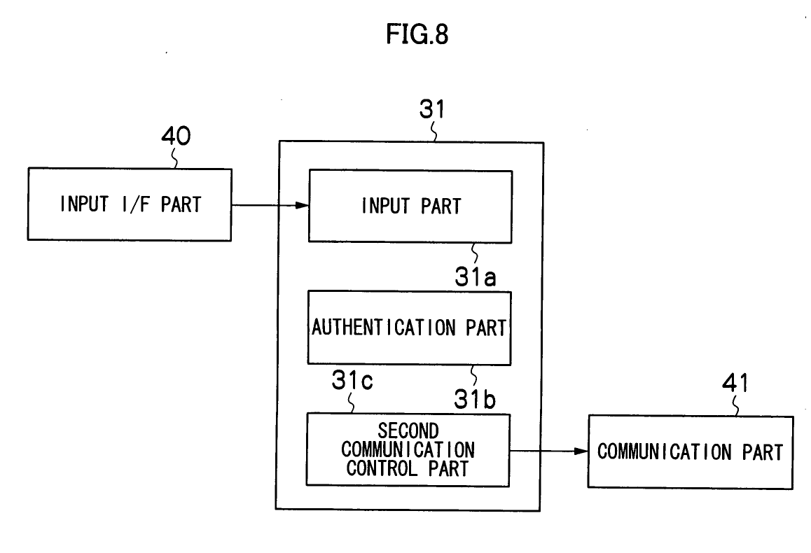

Referring to FIG. 8, a control program performed by the control part 31 of the printer 30 will be described below. The control program comprises an input part 31a for accepting an input of the unique pattern from the input I/F part 40, an authentication part 31b for making the connection authentication of the digital camera 20 based on the inputted unique pattern, and a second communication control part 31c for controlling the wireless communication with the digital camera 20 by the communication part 41 after connection authentication. The control part 31 loads these control programs onto the memory part 37 to be executed by the CPU.

### [Processing Flow]

The processing flow of the first embodiment will be described below. The digital camera 20 flashes the backlight 51b of the existent LCD 51 or the display (power) LED 52 periodically at lighting periods according to the unique pattern for each device of the digital camera 20, and the printer 30 recognizes the flashing pattern to make the connection authentication.

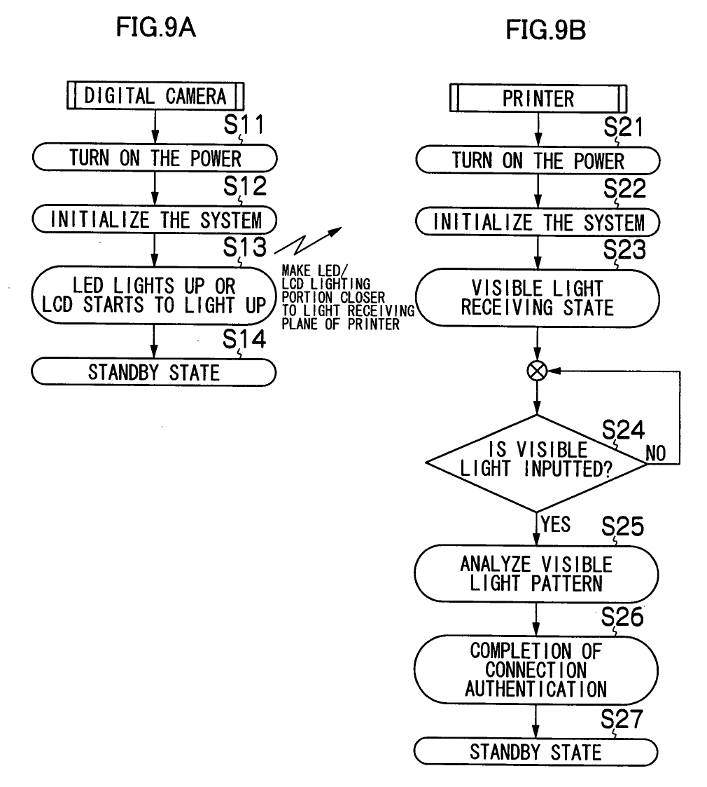

FIGS. 9A and 9B are flowcharts showing the processing flow of connection authentication. Referring to FIGS. 9A and 9B, first of all, a process of the digital camera 20 to output a prescribed flashing pattern for connection authentication to the printer 30 will be described below. FIG. 9A is a flowchart showing the processing flow of the digital camera 20 to output the prescribed flashing pattern to the printer 30.

### (Step S11)

The user turns on the power of the digital camera 20 (S11).

### (Step S12)

The control part 22 initializes the system of the digital camera 22 (S12). The generator 22a generates the prescribed flashing pattern as the unique pattern capable of identifying uniquely the digital camera 20.

### (Step S13)

The pattern control part 22b controls the display part 25 (backlight 51b of the LCD 51 or the LED 52) to flash, based on the flashing pattern generated at step S11. Thereby, the display part 25 emits and flashes visible light in accordance with the unique pattern (S13).

### (Step S14)

The digital camera 20 is kept in a standby state until the connection authentication is completed.

Referring to FIG. 9B, a process of the printer 30 to make the connection authentication of the digital camera 20 based on the prescribed flashing pattern will be described below. FIG. 9B is a flowchart showing the processing flow of the printer 30 to make the connection authentication of the digital camera 20.

### (Step S21)

The user turns on the power of the printer 30 (S21).

### (Step S22)

The control part 31 initializes the system of the printer 30 (S22).

### (Step S23)

The input I/F part 40 is made ready for receiving visible light from the digital camera 20 (S23).

### (Step S24)

The control part 31 determines the presence or absence of the input of visible light (S24). If the user makes a lighting portion of the backlight 51b of the LCD 51 or the LED 52 closer to the light receiving plane (input I/F part 40) of the printer 30 having the phototransistor 43, the visible light flashed according to the unique pattern is received on the light receiving plane. In this case, “Yes” is concluded, and the procedure goes to S25. If light is not received, “No” is concluded, and the procedure returns to S24.

### (Step S25)

The authentication part 31b makes the connection authentication of the digital camera 20 based on the flashing pattern (S25). The authentication part 31b analyzes the unique pattern acquired by the input part 31a via the input I/F part 40 to identify the digital camera 20 uniquely. When the unique pattern indicates the IP address or MAC address, the connection authentication is made based on the analysis value in accordance with the communication protocol.

On the other hand, if the flashing pattern corresponds to the serial number of the digital camera 20, the printer 30 generates a table in which the serial number and its digital camera 20 are associated at the initial time of connection authentication, and thereafter makes the connection authentication by referring to the analysis value and the table.

### (Steps S26 and S27)

The authentication part 31b completes the connection authentication (S26), and the printer 30 is kept in a standby state (S27).

After the above connection authentication process, a wireless communication path is established between the communication part 27 of the digital camera 20 and the communication part 41 of the printer 30 to transmit or receive large capacity data such as image data.

With the above embodiment, a communication device such as the digital camera 20 only requires a long distance communication device (wireless communication device). For the connection authentication, the backlight 51b of the LCD 51 or the LED 52 mounted on the conventional device is used, and a communication device such as the printer 30 recognizes its flashing pattern through a simple circuit to specify the device and make the connection authentication. Therefore, no dedicated hardware for authentication connection is required, whereby the connection authentication between devices is allowed by a simple operation of making the LCD 51 or the LED 52 closer to the printer 30 in the wireless communication system, with no increase in cost.

Though in the above explanation, the flashing pattern is the one in which the light is turned on and off, the flashing pattern may be changed in the light emitting level indicating the light emission strength or the light color.

### Second Embodiment

In a second embodiment, the connection authentication is made using a report device for presenting the information or invoking the attention through the hearing of the user, for example, a sound generator for generating a beep sound.

### [Schematic Configuration of System]

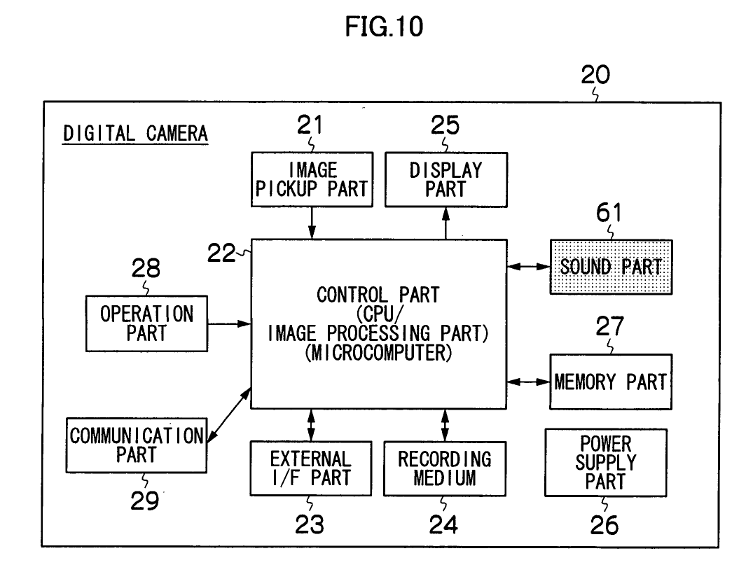

Referring to FIG. 10, the hardware configuration of the digital camera 20 will be described below. FIG. 10 is a schematic block diagram showing the configuration of the digital camera 20.

The digital camera 20 further comprises a sound part 61. The sound part 61 includes a loudspeaker and a microphone (a report device) for recording the sound and reproducing and outputting the recorded sound. The digital camera 20 produces the sound based on a prescribed sound pattern from the sound part 61.

A control program of the digital camera 20 generates a signal having a frequency component of the unique pattern in the generator 22a, and the pattern control part 22b outputs a sound signal having its unique pattern from the sound part 61.

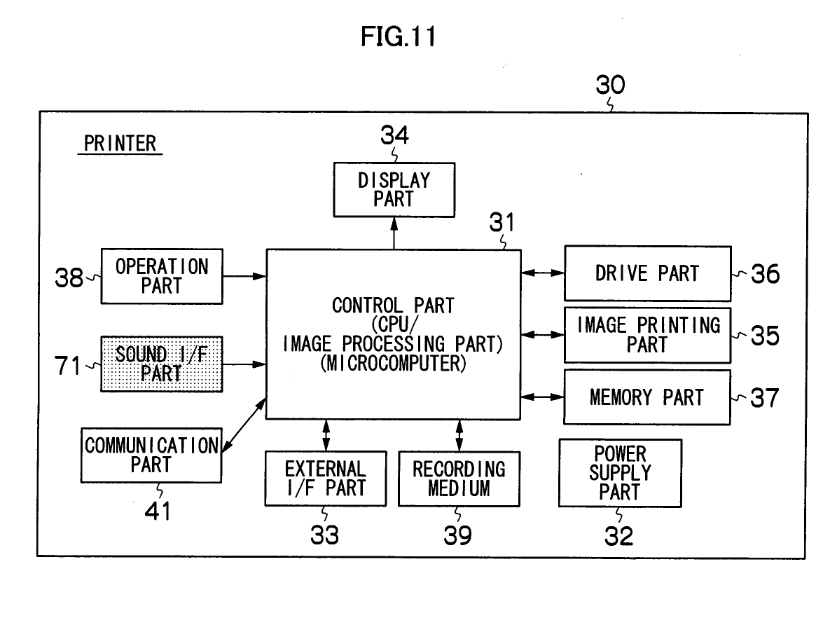

Referring to FIG. 11, the hardware configuration of the printer 30 will be described below. FIG. 11 is a schematic block diagram showing the configuration of the printer 30.

The printer 30 further comprises a sound I/F part 71. The sound I/F part 71 includes a microphone (an input device) for inputting the sound.

Also, the authentication part 31b of the control program for the printer 30 makes the connection authentication based on the sound inputted from the microphone, in which the sound inputted from the microphone may be subjected to a Fourier transform (FFT) process to extract the unique frequency signal.

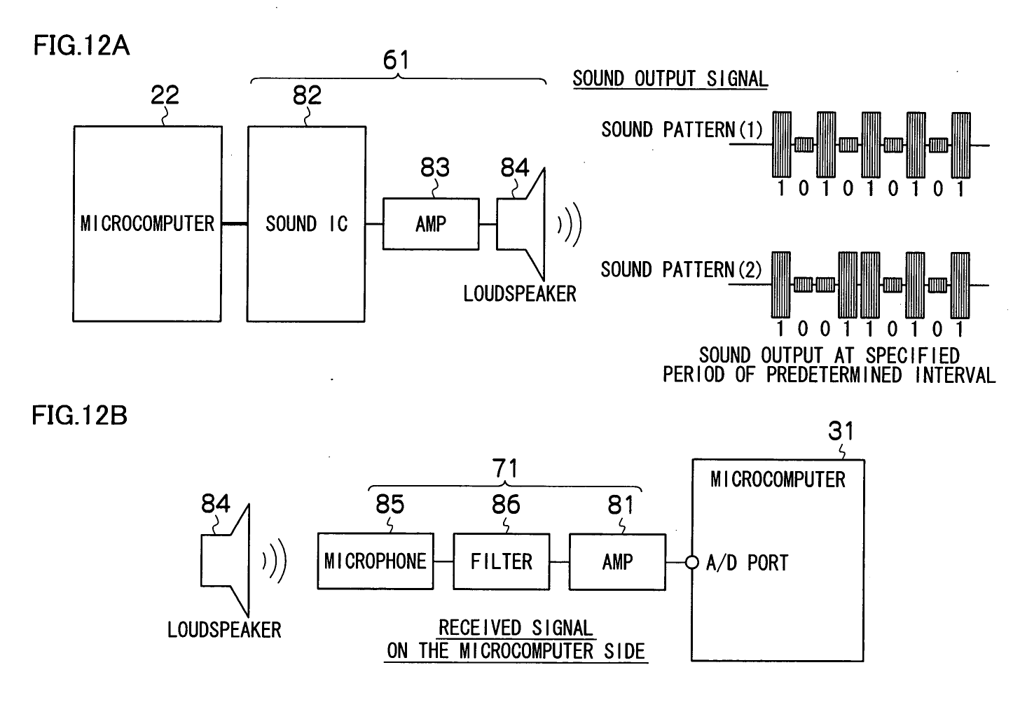

Referring to FIGS. 12A and 12B, the connection authentication operation using the sound pattern will be described below. FIGS. 12A and 12B are schematic diagrams for explaining the connection authentication operation using the sound pattern. In the second embodiment, the sound (e.g., beep sound) is outputted periodically according to the individual pattern of each device, using an existent loudspeaker 84 provided for the digital camera 20, and its unique pattern is received by a microphone 85 on the receiving side (the side of the printer 30) and recognized to make the connection authentication. The sound pattern can be produced differently for each device by changing software of the digital camera 20.

FIG. 12A is a diagram showing the hardware configuration of the sound part 61 in the digital camera 20.

In FIG. 12A, the microcomputer 22, a sound IC 82, an amplifier 83, and the loudspeaker 84 are connected. The microcomputer 22 sends a control signal corresponding to the sound pattern 1 or 2 to the sound IC 82. The sound IC 82 produces a sound signal, which is then amplified by the amplifier 83, and sent to the loudspeaker 84. The loudspeaker 84 outputs the sound.

Thereby, the sound patterns 1 and 2 (indicated at 1 for sound output and at 0 for sound stop) are generated, and outputted at a specific period of predetermined interval. The sound pattern is not the fixed pattern but may be a composite sound signal from the aspect of security, or the unique ID pattern may be generated by making the frequency conversion through the FFT process on the receiving side (printer 30).

FIG. 12B is a diagram showing the hardware configuration of the sound I/F part 71 in the printer 30. In FIG. 12B, the microphone 85 built in the printer 30, a filter 86, an amplifier 87 and the microcomputer 31 are connected. The microphone 85 receives the sound of the loudspeaker 84 and generates a sound signal. The sound signal is passed through the filter 86, amplified by the amplifier 87, and inputted into the microcomputer 31. In the microcomputer 31, the inputted sound signal is converted into digital signal at the A/D port. Thereby, the sound pattern 1, 2 (indicated at 1 for sound output and at 0 for sound stop) is received by the printer 30.

### [Processing Flow]

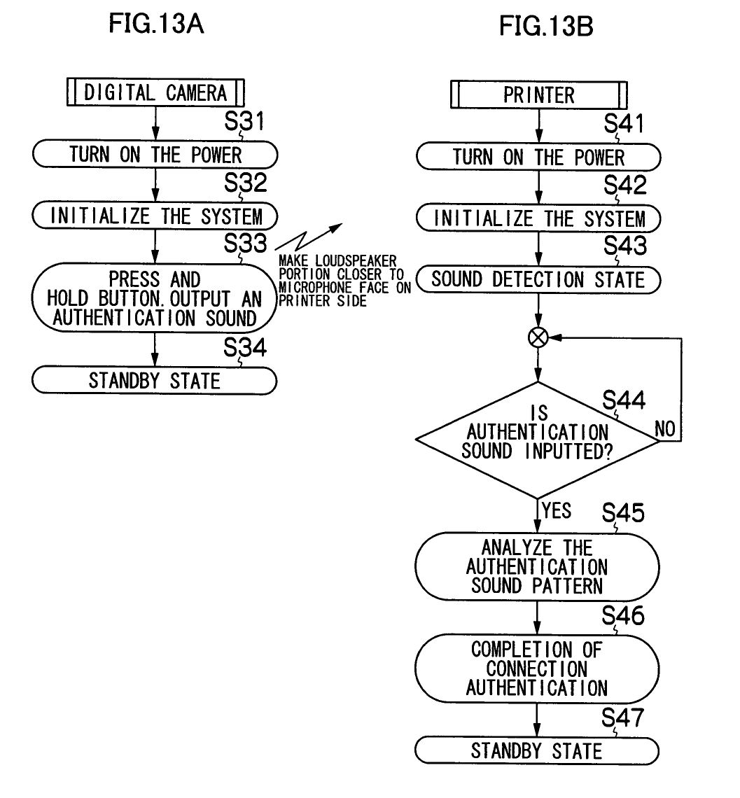

Referring to FIGS. 13A and 13B, the processing flow will be described below. FIGS. 13A and 13B are flowcharts showing the processing flow of connection authentication using the sound pattern. Referring to FIG. 13A, first of all, a process of the digital camera 20 to transmit the sound pattern for connection authentication to the printer 30 will be described below. FIG. 13A is a flowchart showing the processing flow of the digital camera 20 to transmit the sound pattern to the printer 30.

### (Steps S31 and S32)

The user turns on the power of the digital camera 20 (S31), and the system is initialized (S32), like steps S11 and S12.

### (Step S33)

The user presses and holds a button of the operation part 28. The generator 22a generates the prescribed sound pattern as the unique pattern. The pattern control part 22b produces the sound based on the sound pattern via the loudspeaker 84 (S33).

### (Step S34)

The digital camera 20 is kept in a standby state until the connection authentication is completed.

Referring to FIG. 13B, a process of the printer 30 to make the connection authentication of the digital camera 20 based on the sound pattern will be described below. FIG. 13B is a flowchart showing the processing flow of the printer 30 to make the connection authentication of the digital camera 20.

### (Steps S41 and S42)

The user turns on the power of the printer 30 (S41), and the system is initialized (S42), like steps S21 and S22.

### (Step S43)

The sound I/F part 71 is kept in a sound detection state (S43). The input part accepts an input of sound from the digital camera 20 via the microphone 85.

### (Step S44)

The control part 31 determines the presence or absence of the input of the sound pattern (S44). If the user presses and holds the button at S33, and makes the loudspeaker 84 of the digital camera 20 closer to the microphone 85 on the side of the printer 30 while outputting the authentication sound, the input part 31a accepts the input of sound via the sound I/F part 71. In this case, “Yes” is concluded, and the procedure goes to S45. Otherwise, “No” is concluded, and step S44 is continued.

### (Step S45)

The authentication part 31b practices the connection authentication for the wireless communication with the digital camera 20, based on the sound pattern (S45). The authentication part 31b makes a Fourier transform process for the sound inputted from the microphone to extract the unique identification information.

### (Steps S46 and S47)

The authentication part completes the connection authentication (S46), and the printer 30 is kept in a standby state (S47), like S26 and S27.

The wireless communication line can be established through the above connection authentication process, thereby making the wireless communication between the digital camera 20 and the printer 30.

With the above embodiment, the communication device for the digital camera 20 is only the long distance communication device (wireless communication device). For the connection authentication, the sound output device mounted on the conventional device is used, and the communication device for the printer 30 recognizes its sound pattern with a simple circuit to specify the device and make the connection authentication. Therefore, no dedicated hardware for authentication connection is required, whereby the connection authentication between devices is allowed by a simple operation in the wireless communication system, with no increase in cost.

Though the repetitive pattern of vocalization and stop as the sound pattern has been described above, the sound pattern may be changed in the sound pressure level, musical interval or tone color.

### Third Embodiment

In a third embodiment, a vibrator (vibration device) that vibrates according to the unique pattern is used as a report device.

### [Schematic Configuration of System]

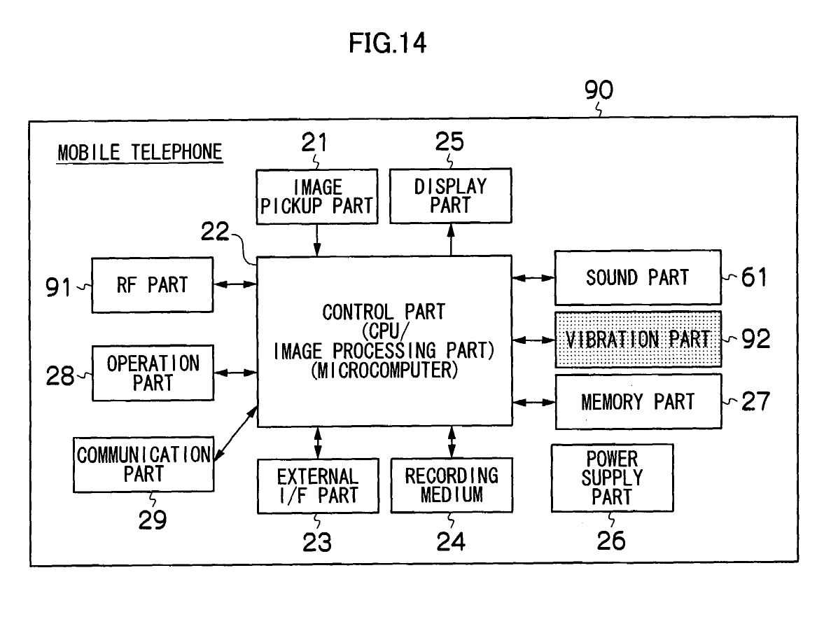

Referring to FIG. 14, the hardware configuration of a mobile telephone 90 will be described below. FIG. 14 is a schematic block diagram showing the configuration of the mobile telephone 90.

In this embodiment, the control part 22 has a CPU for making various controls of the mobile telephone 90 as the core, in which image data from the image pickup part 21 or image data from the recording medium 24 is subjected to various kinds of image processing/conversion to generate display data or recording data. Also, it controls the speech communication or the operation in various modes.

The recording medium 24 is removable recording media, or recording media built into the mobile telephone 90, or may be a writable, erasable large capacity storage such as memory, HDD or DVD. The recording medium 24 stores photographed image data after image processing, text data and various sorts of information.

The operation part 28 is composed of a user I/F such as KEY, a touch panel and so on. A signal inputted by the operation part 28 is sent to the CPU of the control part. The operation or mode of the mobile telephone 90 is set up and controlled in accordance with a state of this operation part 28. The sound part 61 includes a loudspeaker and a microphone, and inputs the sound for speech communication and outputs the received sound. An RF part 91 is composed of an antenna and an I/F module for portable communication, and makes the transmission or reception for speech communication.

A vibration part 92 is composed of a motor, and has a vibrator function.

The communication part 29 has a function of making the wireless transmission and reception of image data.

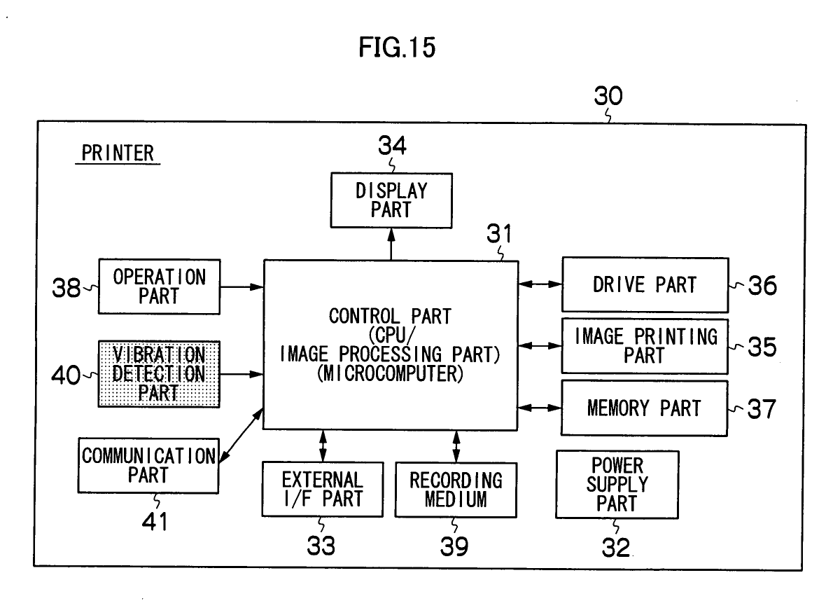

Referring to FIG. 15, the hardware configuration of the printer 30 will be described below. FIG. 15 is a schematic block diagram showing the configuration of the printer 30.

The printer 30 has a vibration detection part 93. The vibration detection part 93 is composed of a shock sensor and detects a vibration pattern from the mobile telephone 90 or other types of device, and processes the vibration pattern within the microcomputer to detect data for connection authentication.

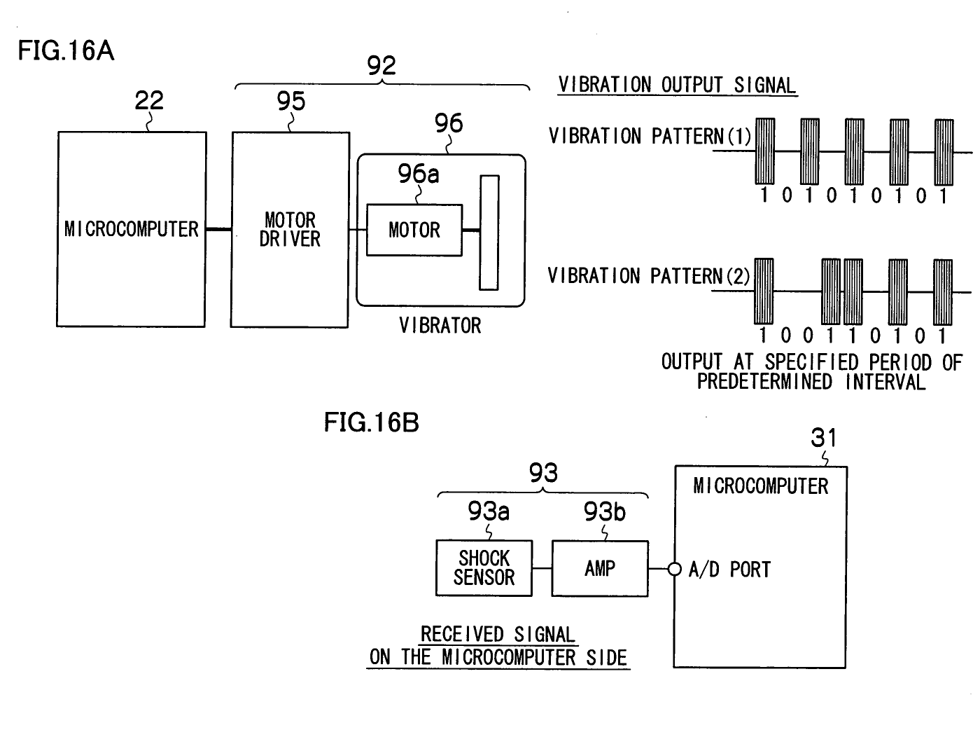

Referring to FIGS. 16A and 16B, a connection authentication operation using the vibration pattern will be described below. FIGS. 16A and 16B are schematic diagrams for explaining the connection authentication operation using the vibration pattern. In the second embodiment, the vibration state is changed periodically according to the individual pattern of each device, using the vibrator function of the mobile telephone 90, and its unique pattern is received by a shock sensor 93a on the receiving side (the side of the printer 30) and recognized to make the connection authentication. The vibration pattern can be produced differently to vibrate each device by changing software.

FIG. 16A is a diagram showing the hardware configuration of the vibration part 92 in the mobile telephone 90. In FIG. 16A, the microcomputer 22, a motor driver 95, and a vibrator 96 are connected. The microcomputer 22 (pattern control part 22b) outputs a control signal corresponding to the vibration pattern 97 or 98 to the motor driver 95. The motor driver 95 drives a motor 96a of the vibrator 96 to vibrate the mobile telephone 90. Thereby, the mechanical vibration is produced based on the vibration pattern 97 or 98 (indicated at 1 for vibration and at 0 for stop), and outputted at a specific period of predetermined interval.

FIG. 16B is a diagram showing the hardware configuration of the vibration detection part 93 in the printer 30. In FIG. 16B, the shock sensor 93a, an amplifier 93b and the microcomputer 31 are connected. The shock sensor 93a detects the vibration of the mobile telephone 90 to generate a reception signal. The reception signal is amplified by the amplifier 93b, and inputted into the microcomputer 31 (input part 31a). In the microcomputer 31, the inputted reception signal is converted into digital signal at the A/D port. Thereby, the vibration pattern 97, 98 is detected by the printer 30.

The vibration pattern may be the MAC address, IP address or serial number of the mobile telephone 90, as in the first embodiment. Also, the vibration pattern is not the fixed pattern but may be the composite vibration from the aspect of security, or the unique ID pattern may be generated by making the frequency conversion through the FFT process on the receiving side (printer 30).

### [Processing Flow]

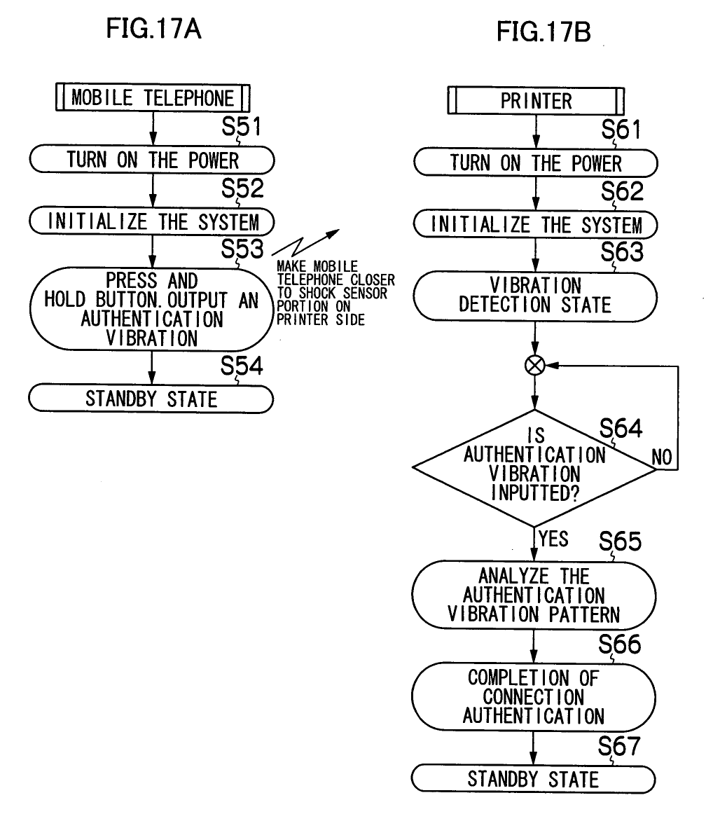

Referring to FIGS. 17A and 17B, the processing flow will be described below. FIGS. 17A and 17B are flowcharts showing the processing flow of connection authentication using the vibration pattern. Referring to FIG. 17A, first of all, a process of the mobile telephone 90 to transmit the vibration pattern for connection authentication to the printer 30 will be described below. FIG. 17A is a flowchart showing the processing flow of the mobile telephone 90 to transmit the vibration pattern to the printer 30.

### (Steps S51 and S52)

The user turns on the power of the mobile telephone 90 (S51), and the system is initialized (S52), like steps S11 and S12.

### (Step S53)

The user presses and holds a button of the operation part 28. The generator 22a generates the prescribed vibration pattern as the unique pattern. The pattern control part 22b controls the vibrator 96 to produce the mechanical vibration based on the vibration pattern (S53).

### (Step S54)

The mobile telephone 90 is kept in a standby state until the connection authentication is completed.

Referring to FIG. 17B, a process of the printer 30 to make the connection authentication of the mobile telephone 90 based on the vibration pattern will be described below. FIG. 17B is a flowchart showing the processing flow of the printer 30 to make the connection authentication of the mobile telephone 90.

### (Steps S61 and S62)

The user turns on the power of the printer 30 (S61), and the system is initialized (S62), like steps S21 and S22.

### (Step S63)

The sound I/F part 71 is kept in a sound detection state (S63). The input part detects the vibration from the mobile telephone 90 via the shock sensor 93a.

### (Step S64)

The control part 31 determines the presence or absence of the input of the vibration pattern (S64). The user produces the authentication vibration at step S53, and lays the vibrator 96 of the mobile telephone 90 on the shock sensor 93a on the side of the printer 30. If the input part 31a detects the vibration pattern, “Yes” is concluded, and the procedure goes to S65. If the input part 31a does not detect the vibration pattern, “No” is concluded, and step S64 is continued.

### (Step S65)

The authentication part 31b practices the connection authentication for the wireless communication with the mobile telephone 90, based on the detected vibration pattern (S65).

The vibration pattern may be the MAC address, IP address or serial number.

### (Steps S66 and S67)

The authentication part 31b completes the connection authentication (S66), and the printer 30 is kept in a standby state (S67), like S26 and S27.

The wireless communication line can be established through the above connection authentication process, thereby making the wireless communication between the mobile telephone 90 and the printer 30.

With the above embodiment, the communication device for the mobile telephone 90 is only the long distance communication device (wireless communication device). For the connection authentication, the vibrator 96 mounted on the conventional device is used, and the communication device for the printer 30 recognizes its vibration pattern with a simple circuit to specify the device and make the connection authentication. Therefore, no dedicated hardware for authentication connection is required, whereby the connection authentication between devices is allowed by a simple operation in the wireless communication system, with no increase in cost.

Though the repetitive pattern of vibration and stop as the vibration pattern has been described above, the vibration pattern may be changed in the vibration strength or vibration frequency.

### Fourth Embodiment

In a fourth embodiment, the connection authentication is made between the digital camera 20 or the mobile telephone 90 (first communication device) and a shop front terminal unit (second communication device) which make the wireless communication.

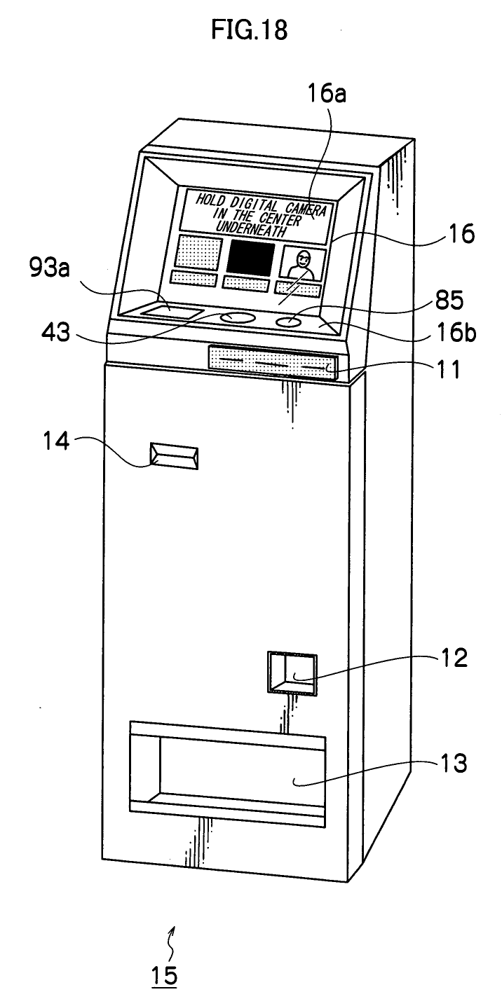

FIG. 18 is a perspective view of a shop front terminal unit 15 according to the invention. The shop front terminal unit 15 is a machine for printing digital image stored in the digital camera 20 or the mobile telephone 90 on the printing medium such as TA (Thermo Autochrome) paper if the user throws in the money. The shop front terminal unit 15 is a shop front information terminal installed over the counter at various shops such as a photo shop, book store, a supermarket and so on, in which the user who purchases the prints usually employs it alone without assistance of the clerk.

The printer 30 is installed inside the shop front terminal unit 15. The printer 30 prints the digital image. The shop front terminal unit 15 is provided with a take-off opening 13, into which the print medium after printing is ejected, in the front outside. Also, the shop front terminal unit is provided with a slot 14 for throwing a settlement device such as coin, bill or prepaid card into a coin machine, and a return opening 12 for returning the change from the coin machine.

The vibration detection part 93 containing the shock sensor 93a, the input I/F part 40 containing the phototransistor 43 and the sound I/F part 71 containing the microphone 85 are installed on the operation plane 16b of the shop front terminal unit 15.

A message for practicing the connection authentication is displayed on the display unit 16a. For example, a message “Hold the digital camera in the center underneath.” is displayed. The user holds or lays the digital camera 20 or the mobile telephone 90 in a predetermined region of the shop front terminal unit 15 to practice the connection authentication.

In making the connection authentication using the flashing pattern as described in the first embodiment, the digital camera 20 or the mobile telephone 90 is made closer to the phototransistor 43. In making the connection authentication using the sound pattern as described in the second embodiment, the mobile telephone 90 or the digital camera 20 is made closer to the microphone 85. In making the connection authentication using the vibration pattern as described in the third embodiment, the digital camera 20 or the mobile telephone 90 is laid on the shock sensor 93a.

When the shop front terminal unit 15 recognizes the flashing pattern of the LCD 51 or the LED 52, recognizes the sound pattern of the loudspeaker 84, or recognizes the vibration pattern of the vibrator 96 from the digital camera 20 or the mobile telephone 90 residing nearby, the wireless communication is enabled. Via the wireless line established by connection authentication, image data is transmitted from the digital camera 20 or the mobile telephone 90. The user may insert the recording medium 24 such as smart media from the digital camera 20 or the mobile telephone 90 into an insertion opening 11 to send image data to the shop front terminal unit 15.

The display unit 16a of liquid crystal type with the touch panel 16 laminated on the front face is disposed in the shop front terminal unit 15, whereby the user operates the touch panel 16 to input required information such as print size, number of prints and so on, while watching the display unit 16a.

If the shop front terminal unit 15 acquires image data from the digital camera 20 or the mobile telephone 90, the control part 31 loads control software recorded on the recording medium 39 into the memory part 37. The control part 31 acquires required image data, makes a required image processing (e.g., expansion of compressed image) and stores the image data after image processing in the memory part 37.

The user inputs various kinds of information regarding the print order such as a selection of image to be printed, number of prints, print type and so on from the touch panel 16. The print type may be designated as digital camera print, divided print, seal print or index print. For the divided print, the number of screen divisions may be designated as 16 divisions, 4 divisions, 2 divisions or no division.

The information regarding the order such as print size, number of prints and so on is inputted via a touch panel interface (I/F) part, not shown, into the control part 31. The control part 31 creates print job data from the image data stored in the memory part 37 and performs a printing process if the required amount of money is thrown in. And the printing medium on which the image is printed is ejected into the take-off opening 13.

Therefore, the connection authentication can be implemented with the same hardware configuration in the home printer such as the printer 30 and the shop front terminal unit 15. In a place where a plurality of shop front terminal units 15 exist, the connection authentication according to the invention can be made to specify the communication party at the other end, thereby preventing false communication with other communication devices.

Moreover, the connection authentication can be implemented using the conventionally provided hardware, whereby there is no increase in cost. Also, a development load of software can be relieved without needing the dedicated or special protocol and addition or change of complex software. The digital camera 20 or the mobile telephone 90 on the transmission side has no addition of hardware and the shop front terminal unit 15 on the receiving side is only composed of the light receiving circuit (low cost components such as phototransistor 43, microphone 85, shock sensor 93a and so on), whereby the simple connection authentication can be implemented.

The present invention is not only applicable to the digital camera 20, the printer 30, the mobile telephone 90, and the shop front terminal unit 15 as described above, but also any other devices for making the connection authentication to establish the wireless communication path.

What is claimed is:

1. A connection authentication system for making wireless communication between a first communication device and a second communication device;
said first communication device comprising:
a generation device for generating a unique pattern capable of identifying uniquely said first communication device;
a report device, used for different purposes from the wireless communication with said second communication device, for presenting an information to a user or invoking an attention of the user, said report device being capable of outputting said unique pattern; and
a first communication unit for making the wireless communication with said second communication device; and
said second communication device comprising:
an input device for accepting an input of said unique pattern;
an authentication device for making a connection authentication of said first communication device based on said unique pattern; and
a second communication unit for making the wireless communication with said first communication device;
wherein if said authentication device of said second communication device authenticates a connection of said first communication device using said unique pattern outputted from the report device of said first communication device, the wireless communication is started between said first communication unit and said second communication unit.

2. The connection authentication system according to claim 1, wherein said first communication device is a portable terminal unit with a camera or an image pickup device that transmits image data by wireless, and said second communication device is an image printer for printing said image data or an image data storage device for storing said image data.

3. A communication device for making wireless communication with other communication devices, comprising:
a generation device for generating a unique pattern capable of identifying uniquely said communication device;
a report device, used for different purposes from the wireless communication with said other communication devices, for presenting an information to a user or invoking an attention of the user, said report device being capable of outputting said unique pattern; and
a communication unit for making the wireless communication with said other communication devices if a connection authentication is made based on said unique pattern.

4. The communication device according to claim 3, wherein said generation device generates a prescribed flashing pattern as said unique pattern, and said report device is a light emitting device for emitting visible light based on said flashing pattern.

5. The communication device according to claim 4, wherein said communication device comprises a liquid crystal monitor or a light emitting diode having a backlight, and said light emitting device is said backlight or light emitting diode.

6. The communication device according to claim 3, wherein said generation device generates a prescribed sound pattern as said unique pattern, and said report device is a sound generator for generating a sound based on said sound pattern.

7. The communication device according to claim 3, wherein said generation device generates a prescribed vibration pattern as said unique pattern, and said report device is a vibrator for generating a mechanical vibration based on said vibration pattern.

8. The communication device according to claim 3, wherein said unique pattern is a signal corresponding to any of an IP address, a MAC address and a serial number of said communication device.

9. The communication device according to claim 7, wherein said unique pattern is a signal corresponding to any of an IP address, a MAC address and a serial number of said communication device.

10. The communication device according to claim 3, wherein said communication device is a portable terminal unit with a camera or an image pickup device capable of making the wireless communication of image data.

11. The communication device according to claim 9, wherein said communication device is a portable terminal unit with a camera or an image pickup device capable of making the wireless communication of image data.

12. A communication device for making wireless communication with other communication devices outputting a unique pattern capable of identifying uniquely the communication device, comprising:
an input device for accepting an input of said unique pattern;
an authentication device for making a connection authentication of said other communication devices based on said unique pattern; and
a communication unit for making the wireless communication with said other communication devices if said connection authentication is made.

13. The communication device according to claim 12, wherein said other communication devices output a visible light emitted based on a prescribed flashing pattern, and said input device is a light receiving device for receiving said visible light.

14. The communication device according to claim 12, wherein said other communication devices produce a sound based on a prescribed sound pattern, and said input device is a microphone for inputting said sound.

15. The communication device according to claim 14, further comprising an extraction device for extracting unique identification information by making a Fourier transform process for the sound inputted from said microphone.

16. The communication device according to claim 12, wherein said other communication devices produce a mechanical vibration based on a prescribed vibration pattern, and said input device is a shock sensor for detecting said vibration.

17. A device for printing an image and/or storing an image data, the device having the communication device according to claim 3.

18. A device for printing an image and/or storing an image data, the device having the communication device according to claim 12.

19. A control program for a communication device having a report device, used for different purposes from wireless communication with other communication devices, for presenting an information to a user or invoking an attention of the user, said program causing a computer to perform:
a step of generating a unique pattern capable of identifying uniquely said communication device; and
a step of outputting said unique pattern from said report device.

20. A connection authentication method for making wireless communication between a first communication device and a second communication device;
said first communication device comprising:
a step of generating a unique pattern capable of identifying uniquely said first communication device;
a step of outputting said unique pattern to a report device, used for different purposes from the wireless communication with said second communication device, for presenting an information to a user or invoking an attention of the user; and
said second communication device comprising:
a step of accepting an input of said unique pattern;
a step of making a connection authentication of said first communication device based on said unique pattern; and
a step of making the wireless communication between said first communication device and said second communication device.
